(19) United States
(12) Patent Application Publication
(10) Pub. No.: US 2017/0241542 A1
(43) Pub. Date: Aug. 24, 2017

(54) CONTROL MODULE

(71) Applicant: JAGUAR LAND ROVER LIMITED, Warwickshire (GB)

(72) Inventor: David PARRY, Whitley, Coventry, Warwickshire (GB)

(21) Appl. No.: 15/506,555

(22) PCT Filed: Aug. 27, 2015
(86) PCT No.: PCT/EP2015/069701

§ 371 Date: Feb. 24, 2017

(30) Foreign Application Priority Data
Aug. 27, 2014 (GB) 1415168.2

(51) Int. Cl. F16H 61/02

(52) U.S. Cl. CPC F16H 61/0213; F16H 59/44

(57) ABSTRACT

The present invention relates to a control module (62) for controlling an automatic gearbox (58). The control module comprises (62) a monitoring module (70) for monitoring one or more parameters of at least one powertrain element. The control module (62) also comprises a determining module arranged to determine a temperature of a powertrain component based on said one or more monitored parameters. The control module (62) also comprises a driving module (60) arranged to detect a driving condition of the vehicle. The control module (62) also comprises an output module (74) arranged to output a downshift command (76) to the automatic gearbox (58) in dependence on the driving condition of the vehicle and on the temperature of the powertrain component exceeding a predetermined threshold, wherein the downshift command selects a gear higher than first gear.

### TECHNICAL FIELD

The present invention relates to a control module for an automatic gearbox of a vehicle, a transmission system and method of controlling the same.

### BACKGROUND

A vehicle such as a car includes a chassis for supporting a plurality of wheels and a power train amongst other things. The power train includes an engine, a transmission system, a prop shaft and near and off-side drive shafts. The engine is coupled to the transmission system and provides power and torque thereto. The transmission system includes a gearbox for scaling the reciprocating power and torque from the engine to a desired power and torque of the prop shaft and subsequently the drive shafts and the driven wheels.

In an automatic car, the gearbox is an automatic gearbox. The automatic gearbox includes a controller for selecting a gear automatically according to a particular set of vehicle conditions. Such a vehicle condition may include vehicle speed. For example, at low speeds, a low gear is selected.

Intermediate the engine and the transmission system is another powertrain component named a torque converter. The torque converter includes an impeller coupled to the engine and a turbine coupled to the transmission system. A circuit of oil is provided within the torque converter to fluidly couple the impeller to the turbine. Rotation of the engine driven impeller induces rotation in the turbine. The difference in rotational speed is the slip speed.

The torque converter acts as a clutch for the automatic gearbox allowing a slip speed between the engine and the gearbox. For example, an engine in a stationary vehicle is allowed to continue running while the powertrain is stationary due to the slip speed of the torque converter. In addition, the torque converter amplifies torque produced by the engine as a result of the slip speed. At high slip speeds, the oil is subjected to high pressure and excessive temperatures. Such temperatures may result in component failure.

There are various ways in which such high slip speeds can occur. For example, in certain vehicle conditions, such as snow or ice on the ground, it may be desirable for the controller of the automatic gearbox to initiate move off from a stationary position in second gear as opposed to first. Doing so will reduce the torque of the driven wheels in an attempt to prevent wheel slips. In such a scenario, a high engine torque is required to deliver the same wheel torque. The increased engine torque input into the torque converter for the same wheel torque will result in a high slip speed. Accordingly the oil is circulated more quickly resulting in excessive temperatures of the torque converter oil due to friction.

It is an object of the present invention to alleviate the aforementioned problem and improve on the prior art.

### SUMMARY OF THE INVENTION

According to an aspect of the present invention there is provided a control module for controlling an automatic gearbox, the control module comprising; a monitoring module for monitoring one or more parameters of at least one powertrain element; a determining module arranged to determine a temperature of a powertrain component based on said one or more monitored parameters; a driving module arranged to detect a driving condition of the vehicle; and an output module arranged to output a downshift command to the automatic gearbox in dependence on the driving condition of the vehicle and on the temperature of the powertrain component exceeding a predetermined threshold, wherein the downshift command selects a gear higher than first gear.

With a control module of the above described aspect, a powertrain component of a vehicle may be protected from excessive temperatures by virtue of a downshift command being executed in the vehicle transmission to reduce torque, and therefore the energy, applied to the powertrain.

At the same time, by only commanding a downshift to a gear higher than first gear, there is less likelihood that vehicle composure will be compromised as a result of a downshift.

The predetermined threshold may be selected in dependence on the detected driving condition of the vehicle.

The driving condition may include one or more of; a driving program setting, an accelerator position, a brake position, a vehicle speed, a vehicle acceleration, a vehicle orientation, a weather type, and a surface type.

The powertrain component may be a torque converter element. The torque converter element may include a torque converter fluid.

The determining module may be arranged to determine temperature indirectly by modelling the temperature of the powertrain component wherein the one or more parameters does not include temperature of the powertrain component.

The at least one powertrain element may be selected from the list of a torque converter, a torque converter turbine, a torque converter impeller, a lock-up clutch, a torque converter fluid, a transmission system hydraulic fluid, and a fluid sump.

The at least one parameter may be selected from the list of a torque converter turbine speed, a torque converter turbine torque, a lock up clutch setting, a torque converter fluid pressure, a transmission system hydraulic pressure, a bulk fluid temperature at the sump, and torque converter slip speed.

According to an aspect of the present invention there is provided a control module comprising; a monitoring module for monitoring one or more parameters of at least one powertrain element; a determining module arranged to determine a temperature of a powertrain component based on said one or more monitored parameters; a driving module arranged to detect a driving condition of the vehicle, wherein the driving condition is indicative of a likelihood of the vehicle composure being compromised by executing a down shift in the automatic gearbox; and an output module arranged to output a downshift command to the automatic gearbox in dependence on the driving condition of the vehicle and on the temperature of the powertrain component exceeding a predetermined threshold.

In embodiments the driving condition may be indicative of a driving program setting, an accelerator position, a brake position, a vehicle speed, a vehicle acceleration, a vehicle orientation, a weather type, and a surface type.

The output module may be configured to inhibit the output of the downshift command in dependence on the detected driving condition of the vehicle.

The downshift command may select a gear higher than first gear in dependence on the driving condition.

The predetermined threshold may be selected in dependence on the detected driving condition of the vehicle.

In embodiments, the predetermined temperature threshold may be set higher, in dependence on the driving conditions, permitting the powertrain components to endure an increased temperature and thereby making the downshift less likely to occur.

In particular the threshold value may include one or more thresholds, forming a threshold index, which takes into account the affect that downshifting will have on the composure of the vehicle. The threshold index may take into account any number of vehicle parameters including wheel slip, lateral acceleration, longitudinal acceleration and/or any other parameter which may affect the composure of the vehicle.

The driving condition may include one or more of; a driving program setting, an accelerator position, a brake position, a vehicle speed, a vehicle acceleration, a vehicle orientation, a weather type, and a surface type.

According to a further aspect of the present invention there is provided a transmission system for a vehicle comprising an automatic gearbox and the aforementioned control module.

According to a further aspect of the present invention there is provided a vehicle comprising the aforementioned transmission system.

According to a further aspect of the present invention there is provided a method of controlling an automatic gearbox, comprising; monitoring one or more parameters of at least one powertrain element; determining a temperature of a powertrain component based on said one or more monitored parameters; detecting a driving condition of the vehicle; and outputting a downshift command to the automatic gearbox in dependence on the driving condition of the vehicle and on the temperature of the powertrain component exceeding a predetermined threshold, wherein the downshift command selects a gear higher than first gear.

Selecting the predetermined threshold may be in dependence on the detected driving condition of the vehicle.

The powertrain component may be a torque converter element. The torque converter element may include a torque converter fluid.

Determining the temperature of the powertrain component may include; modelling the temperature of the powertrain component wherein the one or more parameters does not include temperature of the powertrain component.

The at least one powertrain element may be selected from the list of a torque converter, a torque converter turbine, a torque converter impeller, a lock-up clutch, a torque converter fluid, a transmission system hydraulic fluid, and a fluid sump.

The at least one parameter may be selected from the list of a torque converter turbine speed, a torque converter turbine torque, a lock up clutch setting, a torque converter fluid pressure, a transmission system hydraulic pressure, a bulk fluid temperature at the sump, and torque converter slip speed.

The driving condition may include one of; a driving program setting, an accelerator position, a brake position, a vehicle speed, a vehicle acceleration, a vehicle orientation, a weather type, and a surface type.

According to a further aspect of the present invention there is provided a method of controlling an automatic gearbox, comprising; monitoring one or more parameters of at least one powertrain element; determining a temperature of a powertrain component based on said one or more monitored parameters; detecting a driving condition of the vehicle, wherein the driving condition is indicative of a likelihood of the vehicle composure being compromised by executing a down shift in the automatic gearbox; and outputting a downshift command to the automatic gearbox in dependence on the driving condition of the vehicle and on the temperature of the powertrain component exceeding a predetermined threshold.

Outputting the downshift command may be inhibited in dependence on the detected driving condition of the vehicle. The downshift command may select a gear higher than first gear in dependence on the driving condition.

Selecting the predetermined threshold may be in dependence on the detected driving condition of the vehicle.

According to a yet further aspect of the present invention there is provided, a control module for controlling an automatic gearbox, the control module comprising; a monitoring module for monitoring one or more parameters of at least one powertrain element; a determining module arranged to determine a temperature of a powertrain component based on the monitored parameter; and an output module arranged to output a downshift command to the automatic gearbox in response to the temperature exceeding a predetermined threshold.

This downshift demand forces the automatic gearbox to downshift to a lower gear. At a lower gear the torque demands of the powertrain are reduced, due to the gearing influence thus resulting in lower temperatures. For example, in the case that a vehicle is required to make progress up an incline at a given velocity, embodiments of the invention can protect a powertrain component from excessive temperatures by requesting a downshift of the vehicle transmission which, in turn, reduces the torque requirement across, for example, a torque converter and the temperature of the same, by virtue of the ratio advantage provided by the lower gear selected in the transmission.

The powertrain component may be a torque converter element. By torque converter element we mean any element which combines with other elements to form the torque converter. The torque converter is the most likely powertrain component to be affected by excessive temperatures due to potential excessive slip speeds and thus most likely to fail. Accordingly, requesting a downshift in gear when an element of the torque converter is deemed to be excessive is the best way to minimize damage to torque converter and other powertrain components.

The torque converter element may include a torque converter fluid. The fluid is the component of the torque converter which increases in heat thus affecting other elements of the torque converter. Accordingly, the fluid is likely to be the element with the highest temperature of the torque converter elements. Requesting the downshift when the fluid exceeds the predetermined threshold is the most confident way to prevent any of the torque converter elements failing due to the excessive temperatures.

The determining module may be arranged to determine temperature indirectly by modelling the temperature of the powertrain component wherein the one or more parameter does not include temperature of the powertrain component.

The alternative is to measuring the temperature of the powertrain component directly is an alternative way in which to determine the temperature of the powertrain component. However, modeling the temperature of the powertrain component indirectly based on other parameters means that a specific temperature sensor is not required thus saving on cost, installation issues, and potential in-services repairs. Modeling the temperature indirectly in this way is particularly advantageous in a case where various other parameters of powertrain components are already being monitored for other purposes.

The at least one powertrain element may be selected from the list of a torque converter, a torque converter turbine, a torque converter impeller, a lock-up clutch, a torque converter fluid, a transmission system hydraulic fluid, and a fluid sump.

The at least one parameter may be selected from the list of a torque converter turbine speed, a torque converter turbine torque, a lock up clutch setting, a torque converter fluid pressure, a transmission system hydraulic pressure, a bulk fluid temperature at the sump, and torque converter slip speed.

According to a further aspect of the present invention there is provided a transmission system for a vehicle comprising an automatic gearbox and the aforementioned control module.

The transmission system may further comprise a driving module arranged to detect a driving condition of the vehicle and configure the automatic gearbox to select a gear higher than first gear based on the driving condition.

The driving condition may include one or more of; a driving program setting (e.g an off-road driving program such as “grass, gravel snow (GGS)”, “mud and ruts”, etc.), an accelerator position, a brake position, a vehicle speed, a vehicle acceleration, a vehicle orientation, a weather type, and a surface type.

The case where second gear is selected for very low speeds, or where a vehicle moves off from stationary, is a particularly important scenario especially for the torque converter due to the resulting high slip speed at this condition.

According to a further aspect of the present invention there is provided a vehicle comprising the aforementioned transmission system.

According to a further aspect of the present invention there is provided a method of controlling an automatic gearbox, comprising; monitoring one or more parameters of at least one powertrain element; determining a temperature of a powertrain component based on the one or more monitored parameters; and outputting a downshift command to the automatic gearbox in response to the temperature exceeding a predetermined threshold.

The powertrain component may be a torque converter element.

The torque converter element may include a torque converter fluid.

Determining the temperature of the powertrain component may include;
modeling the temperature of the powertrain component wherein the one or
more parameters does not include temperature of the powertrain component.

The at least one powertrain element may be selected from the list of a torque converter, a torque converter turbine, a torque converter impeller, a lock-up clutch, a torque converter fluid, a transmission system hydraulic fluid, and a fluid sump.

The at least one parameter may be selected from the list of a torque converter turbine speed, a torque converter turbine torque, a lock up clutch setting, a torque converter fluid pressure, a transmission system hydraulic pressure, a bulk fluid temperature at the sump, and torque converter slip speed.

The method may comprise;
detecting a driving condition of the vehicle; and
configuring the automatic gearbox to select a gear higher than first gear based on the driving condition, prior to outputting the downshift command to the automatic gearbox.

The driving condition may include one of; a driving program setting, an accelerator position, a brake position, a vehicle speed, a vehicle acceleration, a vehicle orientation, a weather type, and a surface type.

According to a further aspect of the present invention, the control module may be configured to output a notification to a human machine interface (HMI) device of the vehicle, in response to the temperature exceeding a predetermined threshold. The notification may comprise an instruction directing the driver to take remedial action to mitigate the effects of excessive temperatures on the powertrain components.

The remedial action may include reducing a throttle actuation and/or taking an alternative route. By advising the driver to take remedial action the at least one powertrain element may be protected from excessive temperatures by, for example, reducing the throttle actuation of the engine, which, in turn, reduces the torque requirement across, for example, a torque converter by virtue of the reduced output of the engine. Alternatively, the driver may be advised to alter their route to one in which the terrain is less demanding on the powertrain components (for example, a route where the incline gradients are less steep).

According to a further aspect of the present invention, the control module may be configured to output a control signal to an electric motor of a hybrid powertrain system of the vehicle, in response to the temperature exceeding a predetermined threshold. The control signal may be indicative of an electric motor drive command for directing the electric motor to drive the wheels of the vehicle. By driving the wheels of the vehicle using the electric motor of the hybrid powertrain, the control module may protect the powertrain components from excessive temperatures by relieving the torque demand across the powertrain elements, whilst maintaining a consistent vehicle speed.

For purposes of this disclosure, it is to be understood that the control module described herein can comprise a control unit or computational device having one or more electronic processors.

A vehicle and/or a system thereof may comprise a single control unit or electronic controller or alternatively different functions of the control module may be embodied in, or hosted in, different control units or controllers.

As used herein, the term “control unit” will be understood to include both a single control unit or controller and a plurality of control units or controllers collectively operating to provide the required control functionality.

A set of instructions could be provided which, when executed, cause said controller(s) or control unit(s) to implement the control techniques described herein (including the method(s) described below). The set of instructions may be embedded in one or more electronic processors, or alternatively, the set of instructions could be provided as software to be executed by one or more electronic processor(s). For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present invention is not intended to be limited to any particular arrangement. In any event, the set of instructions described above may be embedded in a computer-readable storage medium (e.g., a non-transitory storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM ad EEPROM); flash memory; or electrical or other types of medium for storing such information/instructions.

Within the scope of this application it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

One or more embodiments of the invention will now be described, by way of example only, with reference to the accompanying drawings, in which:

FIG. 1 shows a schematic of a vehicle including a control module according to the present invention;

FIG. 2 shows an exploded perspective view of a torque converter from FIG. 1;

FIG. 3 shows a transmission system from FIG. 1; and

FIG. 4 shows the control module from FIG. 1.

### DETAILED DESCRIPTION

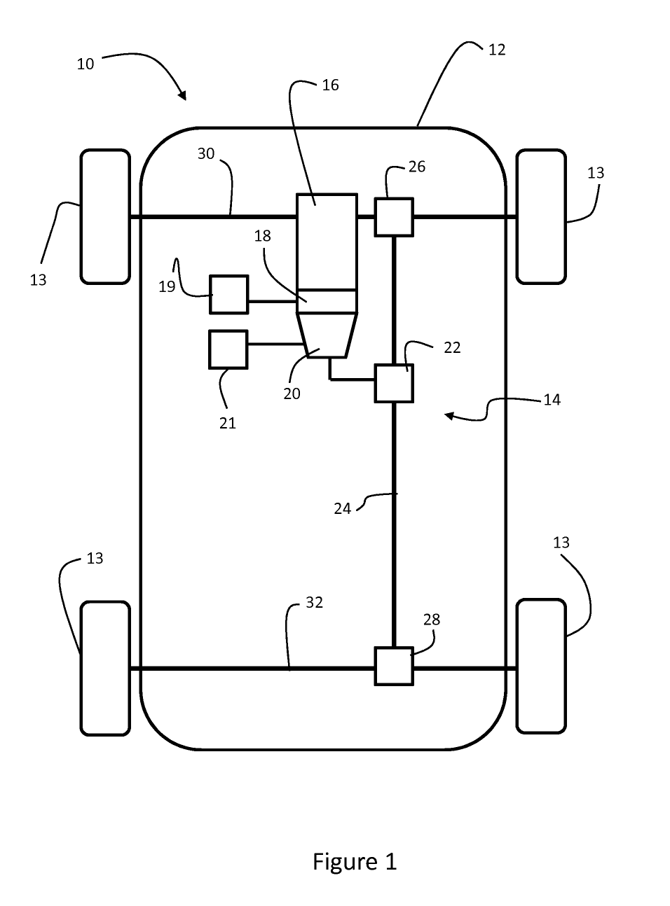

With reference to FIG. 1, a vehicle 10, such as a car, includes a chassis 12 for supporting various components and systems such as a set of four wheels 13 and a powertrain 14 for powering the wheels.

The powertrain 14 includes an engine 16 having an output shaft coupled to a torque converter 18, an oil sump 19, a transmission system 20, a transmission system hydraulic fluid 21, a transfer box 22, a prop-shaft 24, front and rear differential gears 26, 28, and front and rear drive shafts 30, 32.

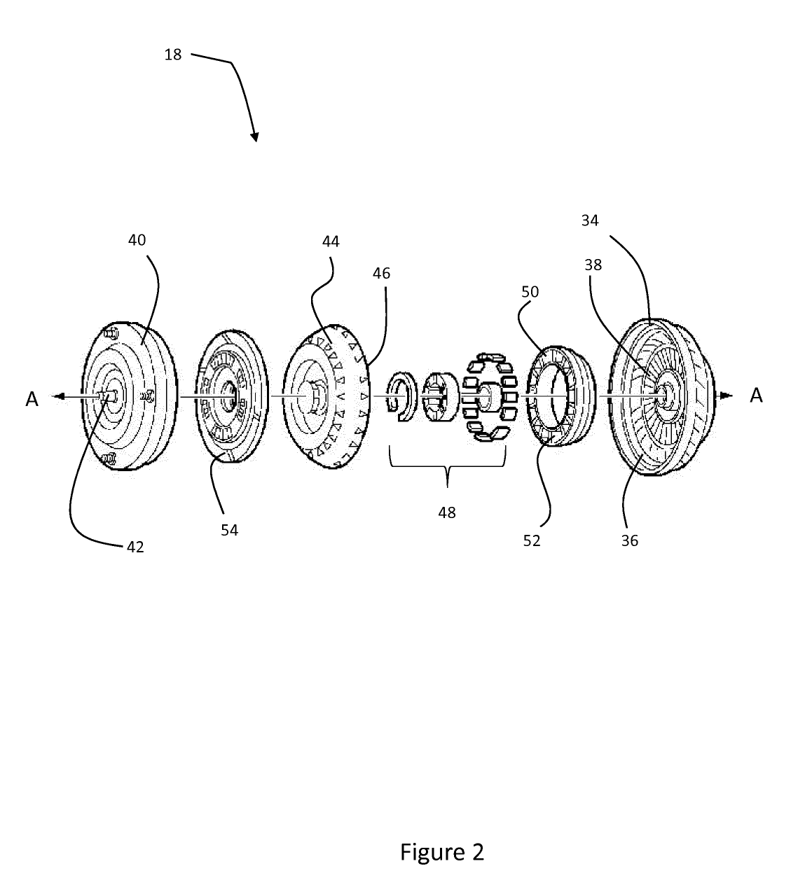

With reference to FIG. 2, the torque converter 18 includes an impeller 34 driven by the engine output shaft (not shown). The impeller 34 includes an interior face 36 supporting a plurality of impeller blades 38. The torque converter also includes a cover 40 attached to the impeller 34 by welding. The cover has a projecting bearing 42 allowing access for the engine output shaft. The torque converter also includes a turbine 44. The turbine 44 has a plurality of turbine blades (not shown) on an interior face 46.

The torque converter 18 also includes a stator 50. The stator 50 includes a plurality of stator blades 52 forming an annular ring within which the one way clutch 48 fits. The stator blades 52 have a relatively high angle of attack to fluid flow travelling in the direction of rotation of the impeller 34 and turbine 44. The stator 50 has two functions. During low speed, the stator 50 is locked to restrict movement, redirecting the fluid expelled by the turbine 44 back into the impeller 34 with the use of its blades. This results in torque amplification. At high speed, the stator 50 becomes free and allows fluid to pass easily into the impeller 34, therefore enhancing efficiency.

The torque converter 18 also includes a one way clutch. The one way clutch 48 prevents the stator 50 from moving in both directions. The stator 50 assembly must be prevented from rotating in one direction in order to amplify the torque.

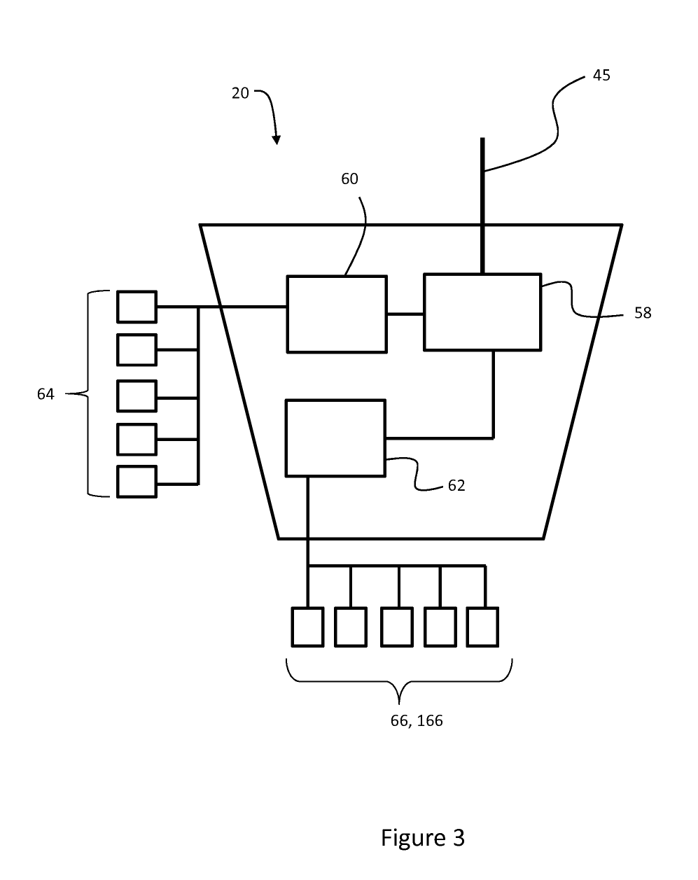

A fluid, namely oil, is provided within the torque converter 18. This oil forms a circuit which includes the oil sump 19 (FIG. 1). When the engine 16 is running, the engine output shaft (not shown) rotates thus rotatably driving the impeller 34. The oil is propelled by the impeller 34 to flow axially along an axis of rotation (A) of the torque converter towards the turbine 44. The oil flow causes an induced flow of the turbine 44 by driving the turbine blades. The turbine is connected to a transmission shaft 45 (FIG. 3) of the transmission system 20. Rotation of the turbine 44 thus causes the same speed of rotation of the transmission shaft 45. There is a difference in speeds between the engine shaft and the transmission shaft 45 due to the fluid coupling of the impeller 34 and the turbine 44. This difference in speeds is known as the slip speed of the torque converter 18. This slip speed results in amplification in torque between the engine output shaft and the transmission shaft 45. Low gear, or low vehicle speed, together with high engine output shaft speed results in a high slip speed and high amplification in torque. The slip speed, and resulting torque amplification, reduces with increasing vehicle speed. It is the high slip speed which results in excessive temperatures of the torque converter 18 since the oil is being worked hard at high slip speeds.

A return flow of oil passing between the turbine 44 and the impeller 34 also passes through the stator blades 52. The high angle of attack of the stator blades 52 deflects the oil sufficiently to reduce the resistance of the impeller 34.

The torque converter 18 also includes a lock up clutch 54. The lock up clutch 54 is connected to both the impeller 34 and the turbine 44. The lock up clutch 54 has several settings. One setting is ‘open’ whereby no resistance to slip is provided between the impeller 34 and the turbine 44. A setting at the other extreme is ‘closed’ whereby the impeller 34 is locked relative to the turbine 44 preventing any slip speed since the two components are mechanically coupled together as opposed to being fluidly coupled together. There are also several graduated degrees of resistance between respective ‘open’ and ‘closed’ settings each providing an increasing degree of resistance to slip of the turbine relative to the impeller. The lock up clutch is particularly useful for high speed driving when no torque amplification is desired and the existence of slip speed results in a degradation in fuel economy.

With reference to FIG. 3, the transmission system 20 includes an automatic gearbox 58 which is coupled to the turbine 44 of the torque converter 18 by the transmission shaft 45. The automatic gearbox 58 includes a planetary gear arrangement. The gears are shifted by hydraulic pressure for the transmission system hydraulic fluid 21.

The transmission system also includes a driving module 60 and a control module 62. The driving module 60 and control module 62 are provided as electrical data on a non-transitory memory component of the vehicle's computer system. The computer system also includes one or more processors for executing the respective modules.

The driving module 60 is arranged to receive various inputs 64 from sensors and/or other modules of the vehicle. These inputs 64 indicate various vehicle conditions to the driving module 60. These vehicle conditions include a driving program setting, an accelerator position, a brake position, a vehicle speed, a vehicle acceleration, a vehicle orientation, a weather type, and a surface type. The driving module 60 is arranged to detect a driving condition of the vehicle 10 and configures the automatic gearbox 58 to select a specific gear based on the driving conditions. For instance, a weather condition such as snow or ice being detected on the ground might result in the driving module configuring the gearbox 58 to select a higher than normal gear for a current vehicle speed. For a stationary vehicle in this case, the gearbox 58 might configure the gearbox 58 to select a gear other than first for commencing driving, or vehicle move off. In this case, the move off gear may be second gear.

Still with reference to FIG. 3, the control module 62 is arranged to receive inputs from various sensors 66 and/or other modules of the vehicle 10. These sensors 66 are positioned throughout the powertrain 14 on various elements thereof, those elements including components and sub-systems of the powertrain 14. The powertrain elements are selected from the list of the torque converter 18, the torque converter turbine 44, the torque converter impeller 34, the lock-up clutch 54, the torque converter fluid or oil, the transmission system hydraulic fluid 21, and the fluid sump 19.

The parameters which the various sensors 66 measure include the torque converter turbine 44 speed, the torque converter turbine 44 torque, the lock up clutch 54 setting, the torque converter 18 fluid pressure, the transmission system hydraulic 21 pressure, the bulk fluid temperature at the sump 19, and torque converter 18 slip speed. The actual sensors 66 are known in the art and are described in no great detail here.

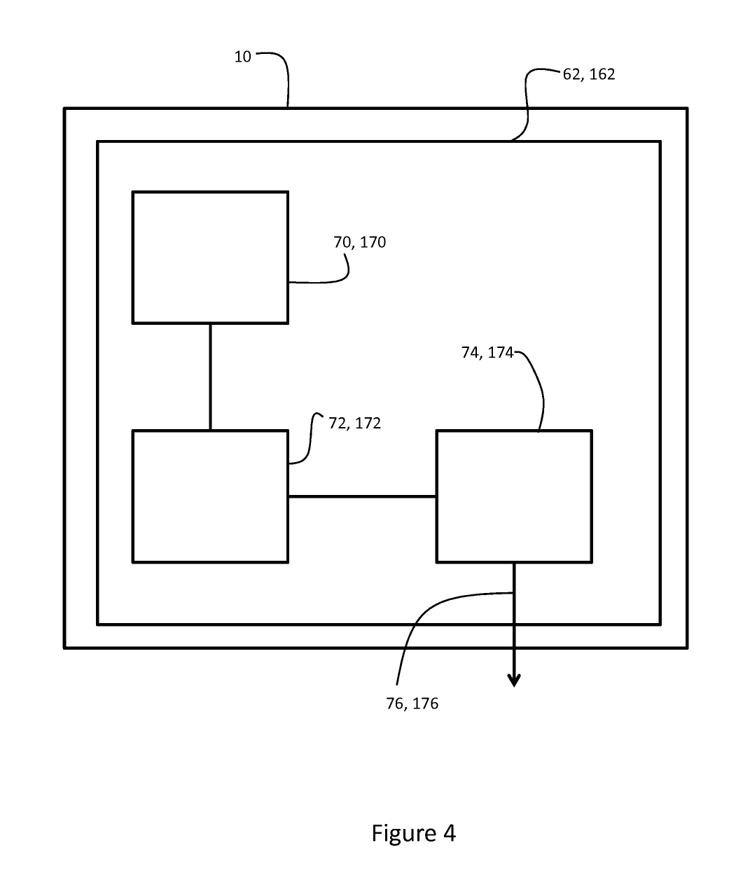

With reference to FIG. 4, the control module 62, for controlling the automatic gearbox 58 (FIG. 3), comprises a monitoring module 70, a determining module 72, and an output module 74.

The monitoring module 70 is communicatively linked to the sensors 64 (FIG. 3). The monitoring module 70 can thus monitor the one or more parameters of any of the elements of the powertrain 14. Specifically, the monitoring module 70 can monitor the torque converter turbine 44 speed, the torque converter turbine 44 torque, the lock up clutch 54 setting, the torque converter 18 fluid pressure, the transmission system hydraulic 21 pressure, the bulk fluid temperature at the sump 19, and torque converter 18 slip speed.

The determining module 72 determines a temperature of the torque converter 18 fluid indirectly by modeling said temperature based on the torque converter turbine 44 speed, the torque converter turbine 44 torque, the lock up clutch 54 setting, the torque converter 18 fluid pressure, the transmission system hydraulic 21 pressure, the bulk fluid temperature at the sump 19, and torque converter 18 slip speed. In this way, the temperature of the torque converter fluid is determined indirectly based on parameters other than the temperature of the torque converter fluid itself. This is advantageous since the other parameters are being monitored by other systems for other purposes and so they can be used here for torque converter fluid temperature determination rather than including another sensor to measure the temperature of the torque converter fluid directly.

The output module 74 compares the modeled temperature of the torque converter 18 fluid to a predetermined temperature threshold. The predetermined temperature threshold is indicative of a fluid temperature which could result in fluid degradation or failure of the one of the torque converter 18 elements, namely the impeller 34, the turbine 44, the stator 50, etc. The predetermined temperature threshold is between 180° C. and 300° C., with 180° C. being the predetermining temperature for most fluids used by torque converters 18.

The output module 74 then outputs a downshift command 76 to the automatic gearbox in response to the temperature of the torque converter 18 fluid exceeding the predetermined threshold. As mentioned above, the highest temperatures experienced by the torque converter 18 fluid are usually when the driving module 60 has configured the gearbox 58 to select a gear higher than first gear for low vehicle speeds such as when the vehicle moves off from stationary, in addition to the driver using excess throttle input. A downshift in gear to first gear results in the slip speed across the torque converter 18 reducing since wheel torque is reduced by selecting a lower gear. When in first gear, the turbine 44 will run slower than when the gearbox is in second gear. This reduction in slip speed reduces the frictional burden on the fluid circulation velocity resulting in a reduction in temperature.

Various modifications can be made to this invention without falling outside of the scope of the subsequent claims. Some of these modifications, or alternative embodiments, are outlined in more detail below. Those features of the subsequent embodiments which are in common with the first embodiment are not repeated for brevity.

In one alternative embodiment, the sensor 166 (FIG. 3) is a thermocouple directly measuring the fluid temperature within the torque converter 118 (FIG. 2). With reference to FIG. 4, the determining module 172 determines the fluid temperature directly based on the thermocouple sensor 166 readings monitored by the monitoring module 170. The output module 174 is again arranged to output a downshift command 174 to the automatic gearbox in response to the temperature of the fluid exceeding the predetermined threshold.

In another alternative embodiment, a temperature of a powertrain component other than the torque converter fluid is determined. For example, the temperature of the gearbox could be determined using the same invention by monitoring one or more parameters of at least one powertrain element; determining a temperature of a powertrain component based on the monitored parameter; and outputting a downshift command to the automatic gearbox in response to the temperature exceeding a predetermined threshold. The predetermined threshold would change in according to a likely failure temperature associated with that component. For example, the temperature at which the gearbox fails might be different to 180° C.

As with the first embodiment, the temperature of the powertrain component can be determined indirectly by modeling the temperature of the powertrain component where the one or more parameters used to model said temperature does not include temperature of the powertrain component itself.

Further aspects of the present invention are set out in the following numbered Clauses:

Clause 1: A control module for controlling an automatic gearbox, the control module comprising;
a monitoring module for monitoring one or more parameters of at least one powertrain element;
a determining module arranged to determine a temperature of a powertrain component based on the monitored parameter; and
an output module arranged to output a downshift command to the automatic gearbox in response to the temperature exceeding a predetermined threshold.
   Clause 2: The control module of Clause 1 wherein the powertrain component is a torque converter element.
   Clause 3: The control module of Clause 2 wherein the torque converter element includes a torque converter fluid.
   Clause 4: The control module of Clause 1 wherein the determining module is arranged to determine temperature indirectly by modelling the temperature of the powertrain component wherein the one or more parameters does not include temperature of the powertrain component.
   Clause 5: The control module of Clause 1 wherein the at least one powertrain element is selected from the list of a torque converter, a torque converter turbine, a torque converter impeller, a lock-up clutch, a torque converter fluid, a transmission system hydraulic fluid, and a fluid sump.
   Clause 6: The control module of Clause 5 wherein the at least one parameter is selected from the list of a torque converter turbine speed, a torque converter turbine torque, a lock up clutch setting, a torque converter fluid pressure, a transmission system hydraulic pressure, a bulk fluid temperature at the sump, and torque converter slip speed.
   Clause 7: A transmission system for a vehicle comprising an automatic gearbox and the control module of Clause 1.
   Clause 8: The transmission system of Clause 7 further comprising a driving module arranged to detect a driving condition of the vehicle and configure the automatic gearbox to select a gear higher than first gear based on the driving condition.
   Clause 9: The transmission system of Clause 8 wherein the driving condition includes one or more of; a driving program setting, an accelerator position, a brake position, a vehicle speed, a vehicle acceleration, a vehicle orientation, a weather type, and a surface type.
   Clause 10: A vehicle comprising the transmission system of any of Clause 7.
   Clause 11: A method of controlling an automatic gearbox, comprising;
monitoring one or more parameters of at least one powertrain element;
determining a temperature of a powertrain component based on the one or more monitored parameters; and
outputting a downshift command to the automatic gearbox in response to the temperature exceeding a predetermined threshold.
   Clause 12: The method of Clause 11 wherein the powertrain component is a torque converter element.
   Clause 13: The method of Clause 12 wherein the torque converter element includes a torque converter fluid.
   Clause 14: The method of any of Clause 11 wherein determining the temperature of the powertrain component includes;
modeling the temperature of the powertrain component wherein the one or more parameters does not include temperature of the powertrain component.
   Clause 15: The method of Clause 11 wherein the at least one powertrain element is selected from the list of a torque converter, a torque converter turbine, a torque converter impeller, a lock-up clutch, a torque converter fluid, a transmission system hydraulic fluid, and a fluid sump.
   Clause 16: The method of Clause 15 wherein the at least one parameter is selected from the list of a torque converter turbine speed, a torque converter turbine torque, a lock up clutch setting, a torque converter fluid pressure, a transmission system hydraulic pressure, a bulk fluid temperature at the sump, and torque converter slip speed.
   Clause 17: The method of Clause 11 comprising;
detecting a driving condition of the vehicle; and
configuring the automatic gearbox to select a gear higher than first gear based on the driving condition, prior to outputting the downshift command to the automatic gearbox.
   Clause 18: The method of Clause 17 wherein the driving condition includes one of; a driving program setting, an accelerator position, a brake position, a vehicle speed, a vehicle acceleration, a vehicle orientation, a weather type, and a surface type.

1-31. (canceled)

32. A control module for controlling an automatic gearbox, the control module comprising;
a monitoring module for monitoring one or more parameters of at least one powertrain element;
a determining module arranged to determine a temperature of a powertrain component based on said one or more monitored parameters;
a driving module arranged to detect a driving condition of the vehicle and select a specific gear based on the driving condition; and
an output module arranged to output the specific gear to the automatic gearbox, and further arranged to output a downshift command to the automatic gearbox in dependence on the driving condition of the vehicle and on the temperature of the powertrain component exceeding a predetermined threshold, wherein the downshift command selects a gear higher than first gear.

33. The control module of claim 32, wherein the predetermined threshold is selected in dependence on the detected driving condition of the vehicle.

34. The control module of claim 32, wherein the driving condition includes one or more of; a driving program setting, an accelerator position, a brake position, a vehicle speed, a vehicle acceleration, a vehicle orientation, a weather type, and a surface type.

35. The control module of claim 32, wherein the powertrain component is at least one of a torque converter element and a torque converter element including a torque converter fluid.

36. The control module of claim 32, wherein the determining module is arranged to determine the temperature indirectly by modelling the temperature of the powertrain component wherein the one or more parameters does not include temperature of the powertrain component.

37. The control module of claim 32, wherein at least one of:
(i) the at least one powertrain element is selected from a torque converter, a torque converter turbine, a torque converter impeller, a lock-up clutch, a torque converter fluid, a transmission system hydraulic fluid, and a fluid sump; and
(ii) the at least one parameter is selected from a torque converter turbine speed, a torque converter turbine torque, a lock up clutch setting, a torque converter fluid pressure, a transmission system hydraulic pressure, a bulk fluid temperature at the sump, and torque converter slip speed.

38. A control module for controlling an automatic gearbox, the control module comprising;
a monitoring module for monitoring one or more parameters of at least one powertrain element;
a determining module arranged to determine a temperature of a powertrain component based on said one or more monitored parameters;
a driving module arranged to detect a driving condition of the vehicle and select a specific gear based on the driving condition, wherein the driving condition is indicative of a likelihood of the vehicle composure being compromised by executing a down shift in the automatic gearbox; and
an output module arranged to output a downshift command to the automatic gearbox in dependence on the driving condition of the vehicle and on the temperature of the powertrain component exceeding a predetermined threshold, wherein the downshift command selects a gear higher than first gear in dependence on the driving condition.

39. The control module of claim 38, wherein the output module is configured to inhibit the output of the downshift command in dependence on the detected driving condition of the vehicle.

40. The control module of claim 38, wherein the predetermined threshold is selected in dependence on the detected driving condition of the vehicle.

41. The control module of claim 38, wherein the driving condition includes one or more of a driving program setting, an accelerator position, a brake position, a vehicle speed, a vehicle acceleration, a vehicle orientation, a weather type, and a surface type.

42. A transmission system for a vehicle comprising an automatic gearbox and the control module of claim 32.

43. A vehicle comprising the transmission system of claim 42.

44. A method of controlling an automatic gearbox, comprising;
monitoring one or more parameters of at least one powertrain element;
determining a temperature of a powertrain component based on said one or more monitored parameters;
detecting a driving condition of the vehicle;
selecting a specific gear based on the driving condition; and
outputting a downshift command to the automatic gearbox in dependence on the driving condition of the vehicle and on the temperature of the powertrain component exceeding a predetermined threshold, wherein the downshift command selects a gear higher than first gear.

45. The method of claim 44, wherein selecting the predetermined threshold is in dependence on the detected driving condition of the vehicle.

46. The method of claim 44, wherein the powertrain component is at least one of a torque converter element and a torque converter element including a torque converter fluid.

47. The method of claim 44, wherein determining the temperature of the powertrain component includes;
modelling the temperature of the powertrain component wherein the one or more parameters does not include temperature of the powertrain component.

48. The method of claim 44, wherein at least one of:
(i) the at least one powertrain element is selected from a torque converter, a torque converter turbine, a torque converter impeller, a lock-up clutch, a torque converter fluid, a transmission system hydraulic fluid, and a fluid sump; and
(ii) the at least one parameter is selected from a torque converter turbine speed, a torque converter turbine torque, a lock up clutch setting, a torque converter fluid pressure, a transmission system hydraulic pressure, a bulk fluid temperature at the sump, and torque converter slip speed.

49. The method of claim 44, wherein the driving condition includes one of; a driving program setting, an accelerator position, a brake position, a vehicle speed, a vehicle acceleration, a vehicle orientation, a weather type, and a surface type.

50. A method of controlling an automatic gearbox, comprising;
monitoring one or more parameters of at least one powertrain element;
determining a temperature of a powertrain component based on said one or more monitored parameters;
detecting a driving condition of the vehicle, wherein the driving condition is indicative of a likelihood of the vehicle composure being compromised by executing a down shift in the automatic gearbox;
selecting a specific gear based on the driving condition; and
outputting a downshift command to the automatic gearbox in dependence on the driving condition of the vehicle and on the temperature of the powertrain component exceeding a predetermined threshold.

51. The method of claim 50, comprising at least one of
inhibiting outputting the downshift command in dependence on the detected driving condition;
the downshift command selects a gear higher than first gear in dependence on the driving condition; and
selecting the predetermined threshold in dependence on the detected driving condition of the vehicle.
